(19) United States
(12) Patent Application Publication
(10) Pub. No.: US 2002/0138328 A1
(43) Pub. Date: Sep. 26, 2002

(54) Staff assignment in a workflow management system

(75) Inventors: Andreas Arning, Rottenburg (DE); Frank Leymann, Aidlingen (DE); Dieter Roller, Schoenaich (DE); Roland Seiffert, Herrenberg (DE)

Correspondence Address: A. Bruce Clay, IBM Corporation T81/503, PO Box 12195, Research Triangle Park, NC, 27709, US

(73) Assignee: International Business Machines Corporation, Armonk, NY (US)

(21) Appl. No.: 10/100,938

(22) Filed: Mar. 19, 2002

(30) Foreign Application Priority Data
Mar. 23, 2001 (EP) 01107239.4

(51) Int. Cl. G06F 17/60

(52) U.S. Cl. 705/9

(57) ABSTRACT

A workflow management system manages a business process or a system with comparable functions. A user is assigned to an activity of the business process using a mining algorithm.

### TECHNICAL FIELD OF THE INVENTION

The invention relates to a workflow management system for managing business processes or functions typically provided by workflow management systems.

### BACKGROUND OF THE INVENTION

The typical basic structure of a business process is that of a graph in which nodes represent the activities that need to be carried out, and the edges represent the sequence in which the various activities are performed. When a workflow management system carries out a particular business process, it assigns an appropriate user to an activity that requires the involvement of a user. If, for example, the activity involves the processing of a document, then the activity would be assigned to a user that can handle the document. Which user should be assigned to the work is specified when the business process is constructed. A specification that relates activities with persons is typically called staff assignment (see Leymann/Roller: Production Workflow: Concepts and Techniques, Prentice-Hall, ISBN 0-13-021753-0 for details).

Staff assignments are typically expressed as queries against an organizational database that holds the set of users working with the workflow management system. The database is either managed by the workflow management system or supplied by a system user. When the activity is being processed, the query is executed, and the user(s) found by the query are assigned to carry out the activity's associated work. When the first user of the set of selected users starts working on the activity, the other selected users of the set are typically unassigned from the activity. Specifying this query is sometimes a difficult task, for example, if it depends on the contents of a document that is processed in the activity.

If, as a result of the query, a user is assigned to the activity and can not handle the work, s/he must route the task to another person who can handle the request. For efficiency, this routing forward of requests should be minimized.

If no query can be specified at all, for example, if the user that needs to perform the work can only be determined by inspecting a document, the approach of assigning the task to a dispatcher is used. The dispatcher then determines, for example, by inspecting the document, the appropriate person that can handle the activity and forwards an appropriate request to the selected person. This procedure depends on the knowledge of the dispatcher and is, therefore, quite unreliable.

### SUMMARY OF THE INVENTION

Therefore, it is an object of the invention to always assign the right user to carry out a particular activity, or in other words, to minimize the assignment of wrong users. The invention uses mining technology for assigning a user to an activity of a business process. With mining technology it is possible to eliminate the need for a dispatcher to determine the appropriate person for an activity, or the necessity for users to indicate they they are not the right person to handle the activity. As a consequence, the use of mining technology provides for a reliable and efficient assignment of users to activities of business processes.

Mining technology uses a specific mining algorithm for each of the activities for which the staff assignment is performed. Finding and adjusting the correct mining algorithm for the actual situation is done in a training stage. In the training phase, a set of documents handled in the activity are selected, and then for each document the users that should handle the document are identified; thus a relationship is constructed between documents and users. This is done without identifying specific properties of the documents. Then a particular mining algorithm or even a set of mining algorithms are created from the documents and the specified relationships. It should be noted that documents are just an example of the type of information that users need to handle. It could also, for example, be information stored in a database accessed by an application program invoked by the user.

At least two methods may be used to establish the relationships needed in the training stage. It is possible to use appropriate information in the audit trail of the workflow management system to derive the relationships between users and the documents associated with an activity. Alternatively, a knowledgeable person may establish these relationships manually.

Typically, a test stage follows the training phase. In the test phase, a set of documents not associated with a person is identified, and the mining algorithm is run to see whether the result is as expected. If multiple mining algorithms are generated in the training phase, the test phase can be used to determine which mining algorithm fits best.

After determining the mining algorithm, it may be used in existing business processes to replace the current staff assignment with one based on mining technology. It may also be used in new business processes for the same document or type of document.

Workflow management systems typically write an audit trail that contains all relevant actions taken when carrying out business processes including some or all of the information that has been used. Periodically inspecting said audit trail and determining how good the assignments of users were can improve the quality and preciseness of the mining algorithm. If, for example, there are still a number of users that were assigned incorrectly (which shows up in the audit trail as transfer of work items), then a new calibration of the mining algorithm needs to be done, preferably using the information in the audit trail.

### BRIEF DESCRIPTION OF THE DRAWINGS

Embodiments of the present invention will now be explained in more detail, by way of example, with reference to the accompanying drawings in which:

FIG. 1 shows a schematic diagram of a business process;

FIG. 2 is a schematic diagram showing how data is passed between activities and passed into and out from an activity of the business process of FIG. 1;

FIG. 3 schematically shows details of the activity of FIG. 2;

FIG. 4 shows an example of the execution of an activity of FIGS. 2 and 3; and

FIG. 5 shows schematically the different phases for determining an appropriate mining algorithm.

### DETAILED DESCRIPTION OF THE INVENTION

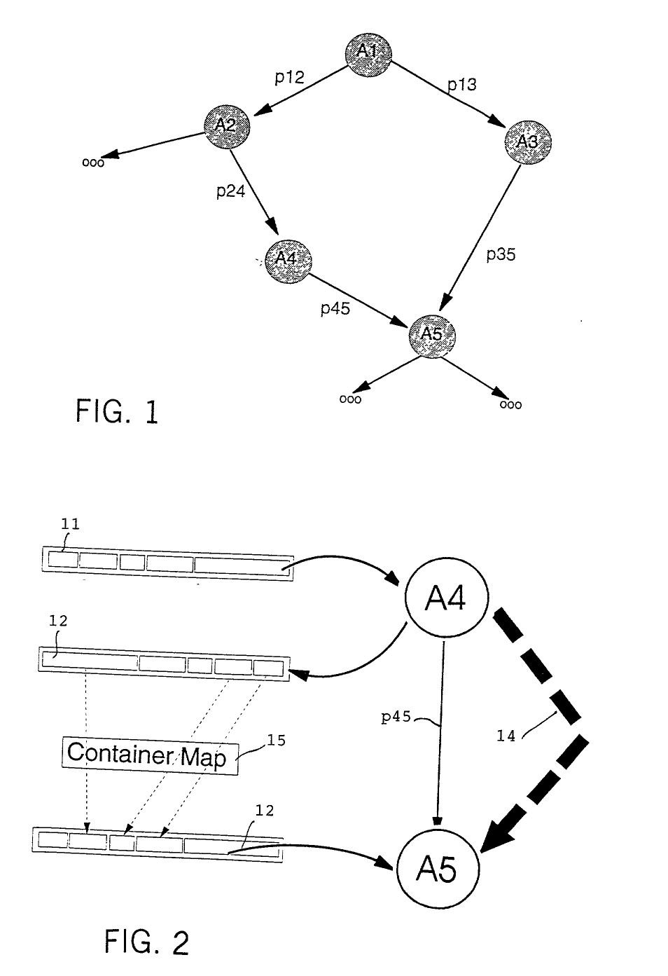

FIG. 1 shows a business process modeled as a graph made up of nodes and edges. The nodes, shown as named circles, represent activities which are the actual work that needs to be performed. The edges, shown as arrows, represent control connectors that describe the sequence in which the activities are to be carried out.

A workflow management system or a system with comparable functions is provided for managing the execution of business processes as shown in FIG. 1. The workflow management system is a computer program being loaded on a computer system.

FIG. 2 shows the two activities A4 and A5 as shown in FIG. 1. Both activities A4 and A5 have an input container 11, 12 associated with them; activity A4 also has an output container 13 associated with it. The input and output containers of an activity are conceptually the signature of the activity. The activity obtains data necessary for its execution from the input container and writes data that it produces and that is needed for other activities into the output container. As with signatures, the containers of an activity are only available to the activity; that means they are only available locally. For example, the input container 11 and the output container 13 are only available to the associated activity A4. Thus, if activity A5 needs data, for example, from the output container 13 of the activity A4, this data must be copied from the output container 13 of the activity A4 to the input container 12 of the activity A5.

For the purpose of copying data from one of the activities to another activity, a data connector 14 is provided which is depicted in FIG. 2 as a dashed arrow. The data connector 14 of FIG. 2 indicates that the output container 13 of the activity A4 has to be copied to the input container 12 of the activity A5.

The output container of an activity and the input container of another activity, however, generally have different data structures, for example' they contain different data fields. Therefore, a container map 15 is provided in FIG. 2 which defines which data fields of the output container 13 of the activity A4 are copied into which data fields of the input container 12 of the activity A5. Also, the container map 15 specifies if a transformation of the data has to be performed by the workflow management system before the data is copied e.g. into the input container 12 of the activity A5.

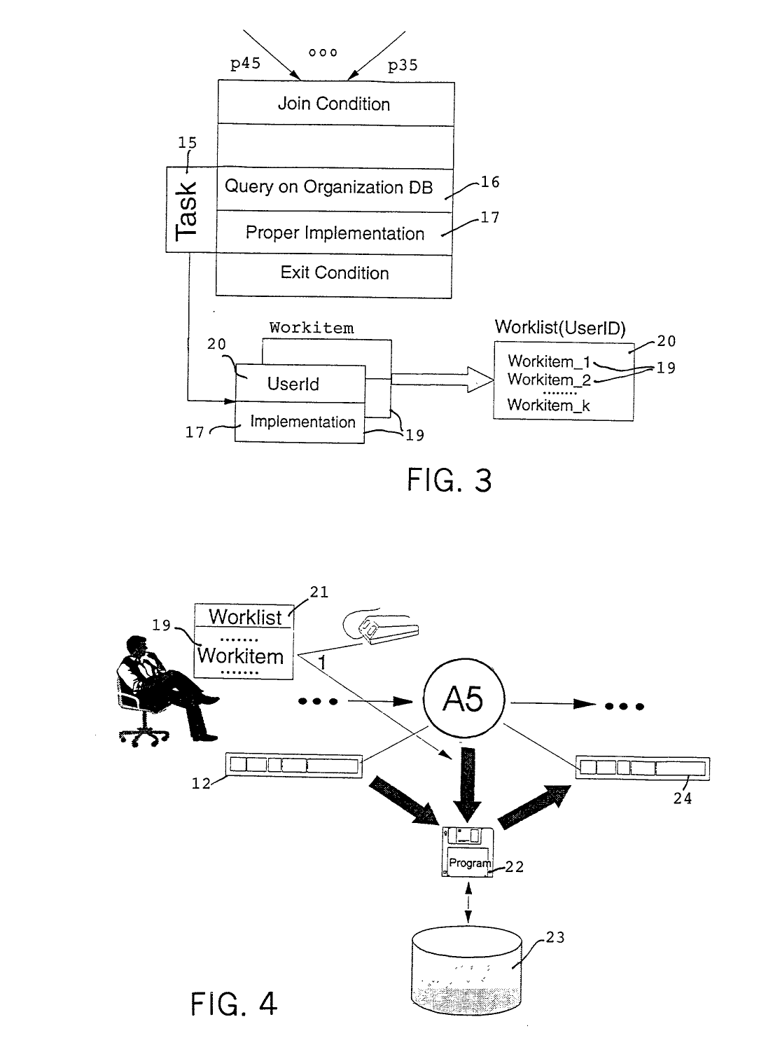

FIG. 3 shows further details of an activity, for example of the activity A5 of FIG. 2. The most important aspects of the activity are the proper implementation of the activity and the user(s) who use the implementation to carry out the activity. Further aspects of an activity are a join condition, an exit condition and so on, which are not described in detail here (further information can be found in Leymann/Roller: Production Workflow: Concepts and Techniques, Prentice-Hall, ISBN 0-13-021753-0).

The query 16 against the organization database is just one particular way of specifying the user/s who should carry out the activity A5. When the query 16 is carried out during processing of the activity, one or more users are selected and assigned to the activity. Specifying how users should be assigned to activities is typically called staff assignment and the process of determining the actual users is called staff resolution. Another way to specify staff assignments is to invoke a user-supplied routine when the staff resolution is done.

The proper implementation 17 defines the tool(s), which users have to use to carry out the activity. A typical implementation 17 could be a word processor used to process a document, with the identification of the document being passed to the word processor via the input container of the activity. Another typical implementation is a program that accesses a database. Quite a few workflow management systems have some implementations already included, such as a forms processor or an e-mail client.

When the workflow management system comes to a particular activity, it performs staff resolution using the specified staff assignment to obtain the user(s) that should carry out the activity, for example using the query 16 against the organization database. For each of the selected user(s), the workflow management system generates a work item 19. A work item conceptually consists of the user identification 20 and the proper implementation 17. For ease of use, the workflow management system typically offers the capability of managing for each user one or more worklists 21.

FIG. 4 illustrates the different steps being taken when a user selects a work item 19 from the worklist 21 presented by the workflow management system. Clicking on an icon that represents the work item typically selects a work item.

First, the workflow management system constructs the input container 12 for the activity A5 using the data connector 14 and container map 15 shown in FIG. 2.

Second, the workflow management system invokes the proper implementation, in this case represented via a program 22 that has to be executed in order to carry out the activity AS. The program 22 obtains the necessary data from the input container 12 and performs the appropriate actions, possibly with additional input from the user. Such action could be the access to a database 23. Other actions could be the sending of an e-mail. The program 22 then puts new data into the output container 24 of the activity AS and then returns to the workflow management system.

Third, the workflow management system continues with the next activity to be processed.

Most business processes have information associated with it that is processed (created, modified, deleted) by the people involved in the business process. Documents are typical pieces of information that are processed in business processes. Other pieces of information are data stored in databases.

It should be noted that a large number of software products have been developed to run business processes that mainly deal with documents, called document management systems. Those systems typically have a workflow management system included within the system without explicitly calling it a workflow management system. The invention also applies to this type of system where the workflow management system is an integral part rather than a separately identifiable system.

In all business processes that have information associated with them as described, the assignment of users to activities typically depends on the attached information, for example on the contents of a document or database record that is processed. In those business processes, mining technology can be used to perform the assignment of a user to a particular activity of the business process, either automatically or at least semi-automatically.

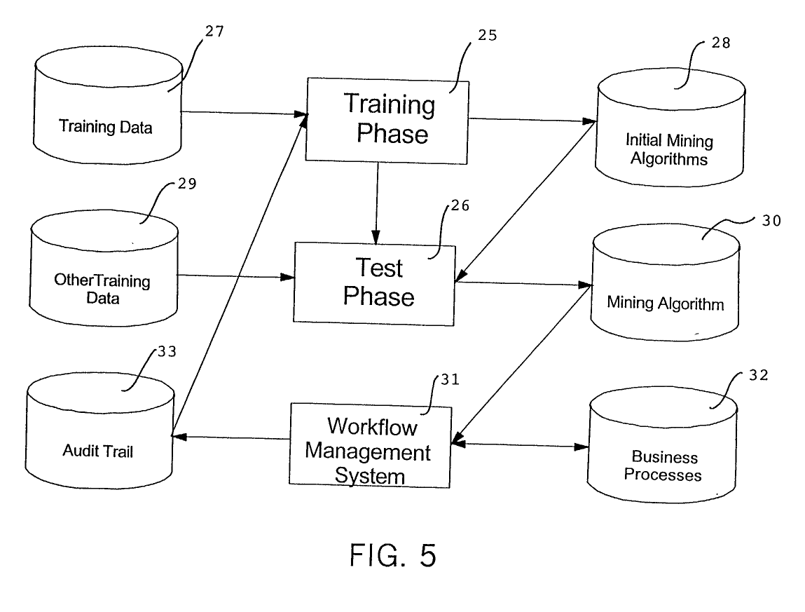

FIG. 5 illustrates the need of mining technology to go through three phases: a training phase 25, an optional testing phase 26, and an application phase 31.

It should be noted that documents are used as an example for illustrating the usage of mining technology by a workflow management system for assigning activities to users within business processes and for explaining the different stages that mining technology goes through in exploitation. This should not be construed as a limitation of the application of the invention and the word document should always be understood just as one example of a piece of information that is associated with a business process.

The training stage 25 consists of (1) defining a set of documents, called training data 27, (2) assigning each document to the user who should handle the document (when later processed in an activity of a business process), and (3) feeding this into a system that provides support for mining technology. Based on the specified relationship between the documents and the assigned user(s), a set of so-called initial mining algorithms 28 is generated.

In the testing stage 26, the set of initial mining algorithms 28 may be improved on the basis of further relationships between additional documents and assigned user(s) that means on the basis of other training data 29. The result is then a mining algorithm 30 that best recognizes the relationships between users and documents; that means to determine a user or a set of users from a given document.

The generated mining algorithm can now be used by any application, be it a workflow management system 31 or any other system, including the system that provides mining technology. This usage by an application is the third phase of mining technology, the application stage 31. In the case of a workflow management system the generated mining algorithm 30 can now assign users to activity.

When such an activity is defined, the staff assignment is not defined as a query against the organization database (see query 16 in FIG. 3) but the invocation of the created mining algorithm 30. The appropriate reference to the document is typically passed to the created mining algorithm via the input container.

When the activity is carried out during execution of a business process, the workflow management system invokes the mining algorithm 30 including passing the reference to the document. After completion, the mining algorithm returns the appropriate set of users, which are then processed by the workflow management system as usual, such as generating work items for each of the selected users.

If the execution of an existing business process 32, that does not exploit mining technology, is managed by the workflow management system as described above, the workflow management system creates the so-called audit trail 33 which comprises information about all actions, including the execution of activities carried out by the workflow management system when executing business processes. In particular, the audit trail 33 comprises information about all documents of all activities of the business processes as well as the corresponding users, which handled the respective documents.

Therefore, the information required in the training phase 25 of exploiting mining technology, that means the relationship between documents and users handling the documents (the training data 27) can be taken from the audit trail 33 of the workflow management system. The generated mining algorithm can then be used to replace the staff assignments in the existing business process.

Independent of how the mining algorithm has been created, whether it was using training data that has been manually constructed or whether it was using training data obtained from the audit trail written by the workflow management system, the audit trail can also be used to improve the generated mining algorithm. Incorrect assignments of users by the mining algorithm show up in the audit trail as transfer of work items from a user to another user. This information can be used as additional training/test data to fine-tune the mining algorithm.

Having thus described a particular embodiment, various alterations, modifications, and improvements will readily occur to those skilled in the art. Such alterations, modifications, and improvements are intended to be part of this disclosure, and are intended to be within the scope of the invention. Accordingly, the foregoing description is by way of example only and is not intending as limiting. It is noted that those skilled in the art will appreciate that various modifications of detail may be made to the preferred embodiments described herein which would come within the scope of the invention as described in the following claims.

What is claimed:

1. A method of operating a computer system, wherein said computer system comprises a workflow management system for managing a business process or a system with comparable functions, and wherein said method comprises the step of assigning a user to an activity of the business process using a mining algorithm.

2. The method of claim 1, further comprising the steps of defining a relationship between the user and pieces of information associated with the business process, and defining the mining algorithm based on this relationship.

3. The method of claim 2, wherein the mining algorithm is created from information in the audit trail written by the workflow management system.

4. The method of claim 3, wherein the mining algorithm is improved from information in the audit trail written by the workflow management system.

5. A computer program product suitable to perform the method of claim 4 when it is loaded into a computer system.

6. A computer system comprising a workflow management system for managing a business process or a system providing comparable functions, wherein said workflow management system comprises an audit trail including information about activities carried out by the workflow management system for managing the business process, and further comprising means for assigning a user to one of the activities based on the information of the audit trail.
